(19) United States
(12) Patent Application Publication
(10) Pub. No.: US 2013/0117043 A1
(43) Pub. Date: May 9, 2013

(54) Wellness Incentive System And Method

(71) Applicant: ARC Technologies, Inc., Overland Park, KS (US)

(72) Inventor: Matthew James Condon, Fairway, KS (US)

(73) Assignee: ARC TECHNOLOGIES, INC., Overland Park, KS (US)

(21) Appl. No.: 13/732,968

(22) Filed: Jan. 2, 2013

Related U.S. Application Data
(63) Continuation-in-part of application No. 12/826,301, filed on Jun. 29, 2010, now abandoned.
(60) Provisional application No. 61/221,407, filed on Jun. 29, 2009.

(51) Int. Cl. G06Q 10/10; G06F 19/00

(52) U.S. Cl. CPC G06Q 10/1057; G06F 19/3456
USPC 705/2; 705/322

(57) ABSTRACT

A system and method for incentivizing the participants' improvement in exercise participation in a health plan including a plurality of participants, without an employer's knowledge of the participants' individual health data. Initially, a randomly-generated identifier is assigned to each of the participants. Next, an exercise schedule is assigned to each of the participants. Points are allocated to each participant based on exercise participation, and incentives are provided for the participants, in the form of prizes awarded to each of the participants based on the number of points respectively allocated. Reports are generated indicating the degree of participation by aggregate participants and by individual participants.

### RELATED APPLICATIONS

This application is a continuation-in-part of U.S. patent application Ser. No. 12/826,301, filed Jun. 29, 2010, which claims priority to U.S. Provisional Patent Application Ser. No. 61/221,402, filed Jun. 29, 2009, the disclosures of which are incorporated herein by reference.

### BACKGROUND

As the U.S. Healthcare Industry evolves and begins to comprehend the cost of lagging attention to preventative care initiatives, ‘wellness initiatives’ have emerged as an important part of the industry's future. To date, the healthcare industry has failed to implement a process that fully engages the needs of employers. It is thus desirable to have a process for capturing data that will beneficially impact both traditional group healthcare cost drivers and workers' compensation cost drivers. Moreover, there is a need for a simple and effective way of providing individualized exercise programs that will mitigate these cost drivers. Furthermore, because of privacy laws and related concerns, there is a growing need to protect the privacy of individual employees' medical health data within an organization.

In addition, it is desirable to avoid potentially dangerous drug interactions among prescribed drugs, and to reduce the likelihood that patients are neglecting or abusing the prescribed medications. This issue becomes more important in the case of a workers' compensation insurance claim, where different doctors, other than the claimant's personal doctor, are normally involved.

### SOLUTION

The present system provides exercise incentives for participants in a group health plan and generates progress reports that keep the identities of the participants anonymous. Initially, a unique random employee number is assigned to each of the participants in a group. A schedule of exercises is then assigned to each of the participants. Points are allocated to each of the participants based on exercise participation information including (1) participation in the exercises assigned, (2) improvement of sub-standard health metrics, and (3) maintenance of acceptable health metrics. A report is generated which indicates the participants' scores based on the percentage of assigned exercises completed by each of the participants, with the identity of each of the participants being referenced only by a corresponding employee number, thus retaining anonymity of the identity of individual participants with respect to the score and the exercise participation information.

In addition, a Pharmacy Management Module provides effective management of prescribed medications while progressing appropriate people off of indicated medications.

### BRIEF DESCRIPTION OF THE DRAWINGS

FIG. 1 is a system diagram showing an exemplary computer system for processing a set of inputs to generate corresponding outputs in one embodiment of the present system;

FIG. 2 is a flowchart showing an exemplary set of steps performed in response to health risk assessment and biological information;

FIG. 3 is a flowchart showing an exemplary set of steps performed in response to personal work comp history and other orthopedic injuries/pain reports;

FIG. 4 is a flowchart showing an exemplary set of steps performed in response to potential target areas as determined by jobsite analysis;

FIG. 5 is a diagram showing an exemplary set of high level steps performed in an exemplary embodiment of the present system;

FIG. 6 is a flowchart showing an exemplary scoring algorithm in an exemplary embodiment of the present system;

FIG. 7 is a flowchart showing an exemplary method for managing pharmaceutical prescriptions; and

FIG. 8 is a flowchart showing exemplary details of step 730, FIG. 7.

### DETAILED DESCRIPTION

The present system and method is an internet-based wellness system that helps businesses' employees become more healthy and physically fit. The system receives inputs including group health carrier wellness criteria, group health aggregate data, government wellness subsidy criteria, members' health screening assessment data, worksite assessment data, and employee-specific injury history including individual and aggregate workers' compensation data from previous claims, and optional self-reported health-related injuries. Aggregate data is data that is combined and analyzed, which is typically the data that health insurance companies consider when determining premium costs per individual and per group. The data is input into a computer-implemented formula that results in a personalized workout plan for each employee (hereinafter ‘participant’) specific to their job segment, health needs, co-morbidity factors, group health risks and group goals.

The present system and method assigns exercises to participants based on several types of the information indicated above, which are collectively unique in the field of health care. Each participant receives recommendations for one cardiovascular exercise plus other targeted exercises, and one or more suggested articles to be read.

Participants optionally have the ability to challenge co-workers and/or other departments within their organization. Participants may earn points by indicating that they have completed certain exercises. Participants may also be able to access their recommended workouts on any Internet-enabled computer or download suggested workouts to a portable device. Participants may also be able to purchase workout equipment for ‘points’ accumulated during the process described below.

In addition, a Pharmacy Management Module provides effective management of prescribed medications while progressing appropriate people off of indicated medications.

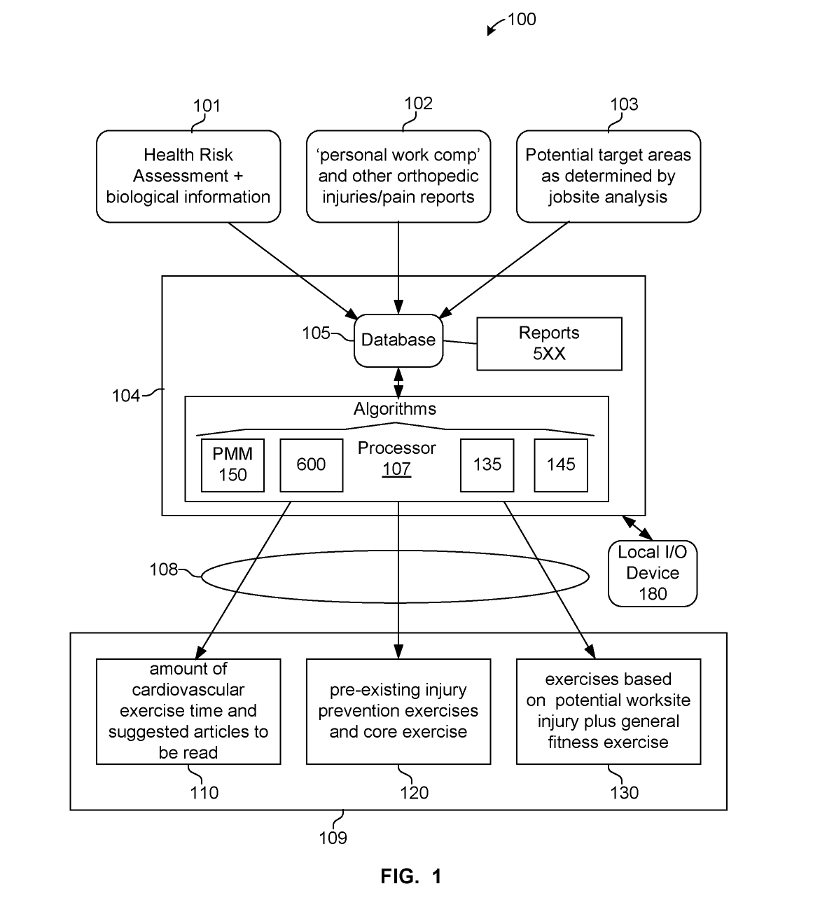

FIG. 1 is a system diagram showing an exemplary system 100 which processes a set of inputs to generate corresponding outputs in one embodiment of the present system and method. As shown in FIG. 1, system 100 comprises a computer system 104 including a processor and associated memory 107 coupled to a database 105 containing records 123 including prescription information and history for each patient/participant handled by the present system.

In an exemplary embodiment, there are three categories of inputs 101, 102, 103, which are input to and stored in database 105 and processed by processor 107 to generate respective outputs 110, 120, 130 in response to health indicators for a particular participant: These inputs and outputs are controlled by algorithms found in module 135.

(1) The results of Health Risk Assessment (HRA) plus biological information (including physical data) 101 on the participant determine the amount of cardiovascular exercise and health-related articles 110 a participant will receive (block 110). Articles and exercise recommendations are sent to participants via the Internet 108 for display on each participant's computer or mobile device 109.

(2) A report 102 including response to a ‘personal work comp history’ including workers' compensation reports for the participant (if any) and self-reported other orthopedic injuries/pain information determines a set of recommended pre-existing injury prevention exercises 120 for the participant. A ‘core’ exercise is also included by default in the recommended set of exercises (block 120). A core exercise is one which uses abdominal, low back, and/or other postural muscles.

(3) Target exercises 130 are generated by a jobsite analysis 103 which is performed by an ergonomic specialist. This jobsite analysis indicates what types of injuries the participant is likely to experience as a result of ergonomic realities of the participant's work environment. The jobsite analysis generates a minimum of one and a maximum of two potential target area inputs exercises based on potential worksite injury plus general fitness exercise (block 130).

In an exemplary embodiment, the exercise(s) recommended for each of the three categories 101, 102, 103 constitutes one-third of the total recommended workout.

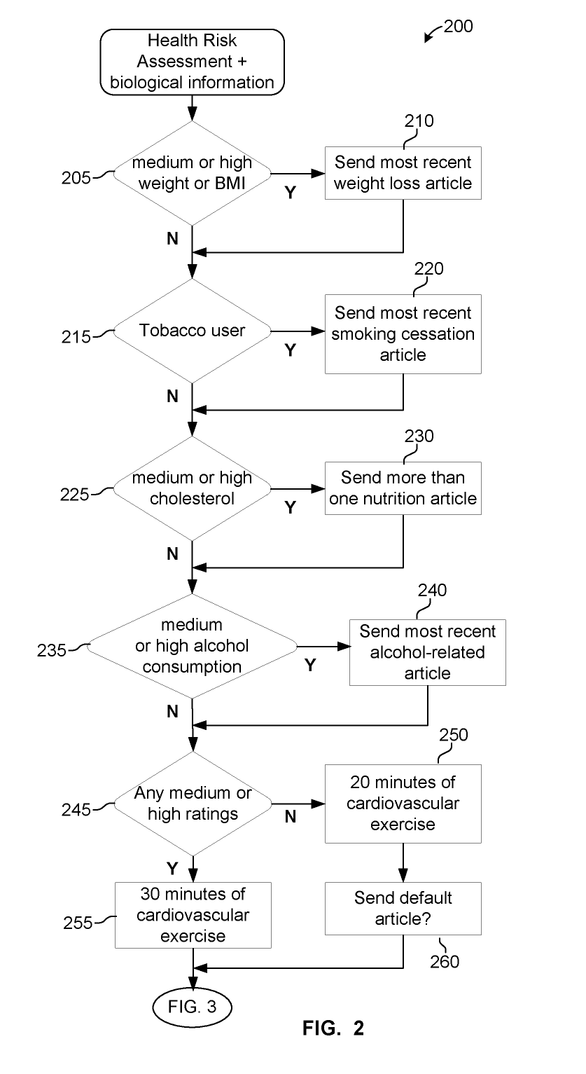

FIG. 2 is a flowchart showing an exemplary set of steps performed in response to health risk assessment and biological information. The results of Health Risk Assessment (HRA) plus biological information on a participant determine the amount of cardiovascular exercise and suggested health-related articles to be read by the participant.

Health Risk Assessments measure factors including some or all of weight, blood sugar, blood pressure, cholesterol, BMI (body mass index, an indicator of body mass relative to height), alcohol use and tobacco use. In an exemplary embodiment, each HRA provides a rating of low, medium or high for each of the above factors.

As shown in FIG. 2, at step 205, if a participant is flagged medium or high with respect to weight, or with medium or high BMI, they will receive a recent weight loss article on their personal system web page, at step 210. If a participant is flagged as a tobacco user (step 215), they will receive the most recent smoking cessation article (step 220), as tobacco use is deemed to put the user in at least a medium risk category. If a participant is flagged with medium or high cholesterol (step 225), they will receive more than one nutrition article (step 230). Optionally, if a participant is flagged for medium or high alcohol consumption (step 235) they will receive a recent alcohol-related article (step 240). Otherwise, a default health-related article is sent to the participant.

In an exemplary embodiment, every participant receives either 20 or 30 minutes of recommended cardiovascular exercise. If a participant receives a medium or high rating on any of the above factors (step 245), they will receive a recommendation for 30 minutes of cardiovascular exercise (step 250). Otherwise they receive a 20 minute exercise recommendation (step 255). ‘Featured’ articles will be made available on an individual home web page which is created for each participant.

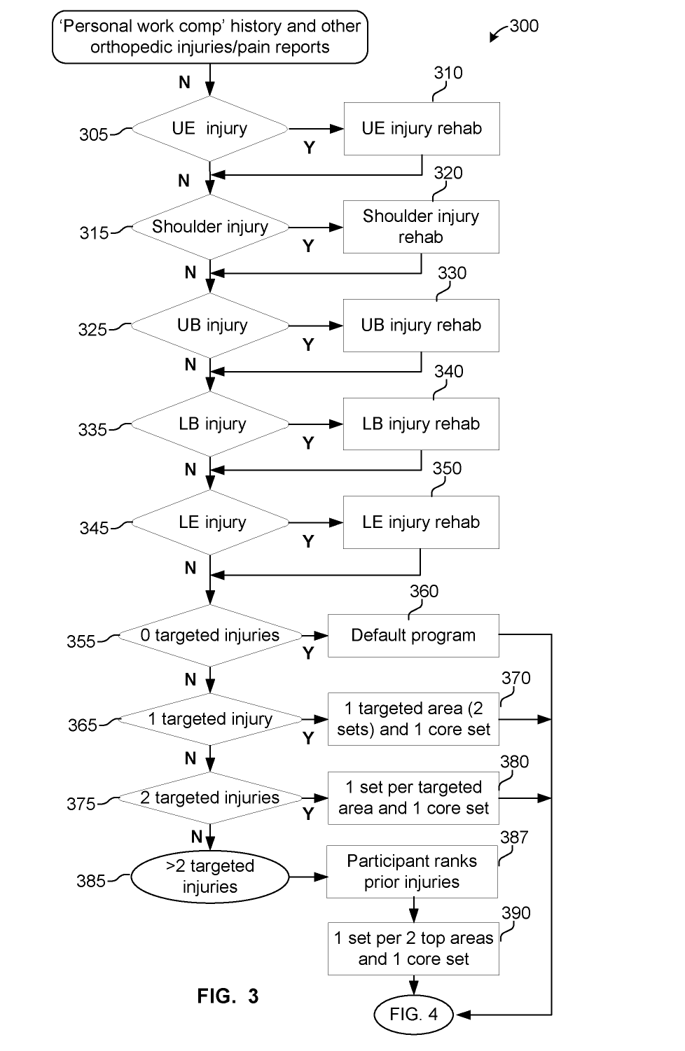

FIG. 3 is a flowchart showing an exemplary set of steps performed in response to personal work comp history and other orthopedic injuries and pain reports. Target area exercises are determined by the response to the participant's personal work comp history and pain indications. This information is generated either by HRA/employee self-report process (input (1), in FIG. 1) and/or responses provided by the employer describing prior work comp injuries they have had treated for the employee, and other self-reported orthopedic injuries/pain indications. Exercise recommendation are accordingly generated to protect the participant from exacerbating previous injuries that will impact the participant's workplace productivity.

As shown in FIG. 3, at step 305, if a participant reports an upper extremity (UE) injury then the participant is flagged for UE injury rehabilitation as a target area, at step 310. If the participant reports a shoulder injury (step 315), then the participant is flagged for shoulder injury rehabilitation as a target area (step 320). If the participant reports an upper back (UB) injury (step 325), then the participant is flagged for UB injury rehabilitation as a target area (step 330). If the participant reports a lower back injury (step 335), then the participant is flagged for lower back (LB) injury rehabilitation as a target area (step 340). If the participant reports a lower extremity (LE) injury (step 345), then the participant is flagged for LE injury rehabilitation as a target area (step 350).

Each participant receives three exercises of six to twenty repetitions based on the following logic. If the participant is not flagged for any targeted areas (step 355), then the participant receives a default program which includes two ‘general’ exercise sets, for example body weight squats and pushups, and one ‘core’ exercise set (step 360). If the participant is flagged for only one targeted area (step 365), then the participant's program includes two exercise sets for the one ‘targeted area’ (as indicated by the injury report) and one core (abdominal, low back, postural) exercise set (step 370).

If the participant is flagged for exactly two targeted areas (step 375), then the participant's program includes one exercise set for each of the two ‘targeted areas’ (as indicated by the injury report)—one exercise set for the first target area, and one exercise set for the second target area, as well as one ‘core’ exercise set (step 380).

If the participant is flagged with more than two targeted areas (step 385), then the participant is instructed to rank the prior injuries according to the participant's perception of the degree to which the injury currently impacts their functioning, so that the system can determine the two potentially most impactful areas, at step 387. The participant's program will then include one exercise set for each of the two top-ranked ‘targeted areas’ (as ranked by the participant)—one exercise set for the top-ranked target area, and one exercise set for the next-to-top-ranked target area, plus one ‘core’ exercise set (step 390).

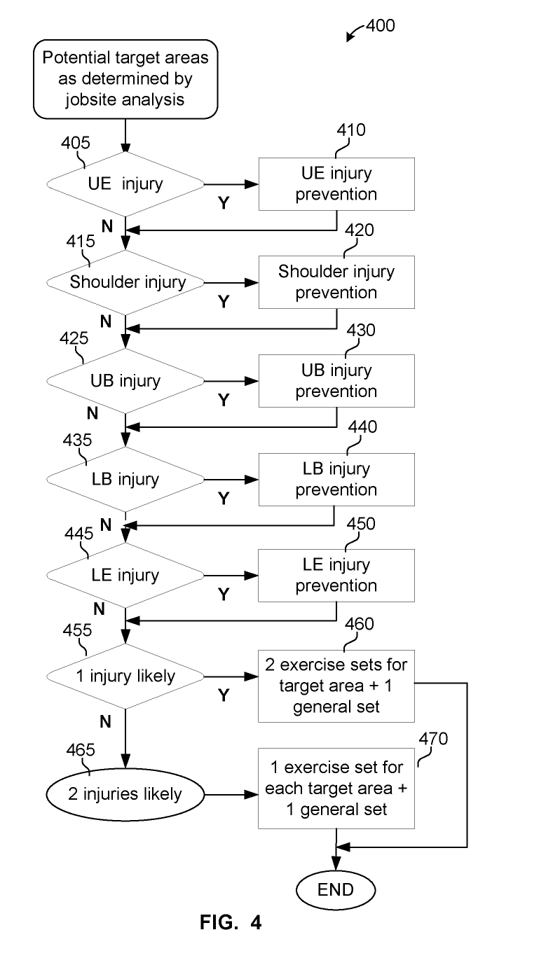

FIG. 4 is a flowchart showing an exemplary set of steps performed in response to potential target areas as determined by jobsite analysis. As shown in FIG. 4, target exercises are generated by a jobsite analysis performed by an ergonomic specialist. In an exemplary embodiment, the jobsite analysis provides a minimum of one and a maximum of two non-employee-specific potential target area inputs representing specific injuries likely to be incurred by employees as a result of the ergonomics of the workplace environment.

At step 405, if jobsite analysis determines that a participant's worksite activity leads to a likelihood of upper extremity (UE) injury, then the participant is flagged for upper extremity injury prevention target area program input, at step 410. If jobsite analysis determines that the participant's worksite leads to likelihood of shoulder injury (step 415), then the participant is flagged for a shoulder injury prevention target area program input (step 420).

If jobsite analysis determines that the participant's worksite activity leads to likelihood of upper back (UB) injury (step 425), then the participant is flagged for upper back injury prevention target area program input (step 430).

If jobsite analysis determines that participant's worksite activity leads to likelihood of lower back (LB) injury (step 435), then the participant is flagged for lower back injury prevention target area program input (step 440). If jobsite analysis determines that the participant's worksite activity leads to likelihood of lower extremity (LE) injury (step 445), then the participant is flagged for lower extremity injury prevention target area program input (step 450).

In an exemplary embodiment, jobsite analysis stipulates a minimum of one and a maximum of two potential injury areas for any given worksite. If jobsite analysis determines that the participant's worksite activity leads to a likelihood of one orthopedic injury (step 455), then the participants program includes two exercise sets for ‘targeted area’ (as directed by the jobsite analysis), and one ‘general’ exercise set, as defined by a ‘general’ pool of exercises, e.g., bodyweight squats (step 460).

If jobsite analysis determines that the participant's worksite activity leads to a likelihood of two different orthopedic injuries (step 465), then the participant's program includes two exercises sets, one for each ‘targeted area’ (as directed by the injury report)—one exercise set for the first targeted area, and one exercise set for the second targeted area, plus one ‘general’ exercise set, as defined by the ‘general’ pool of exercises (step 470).

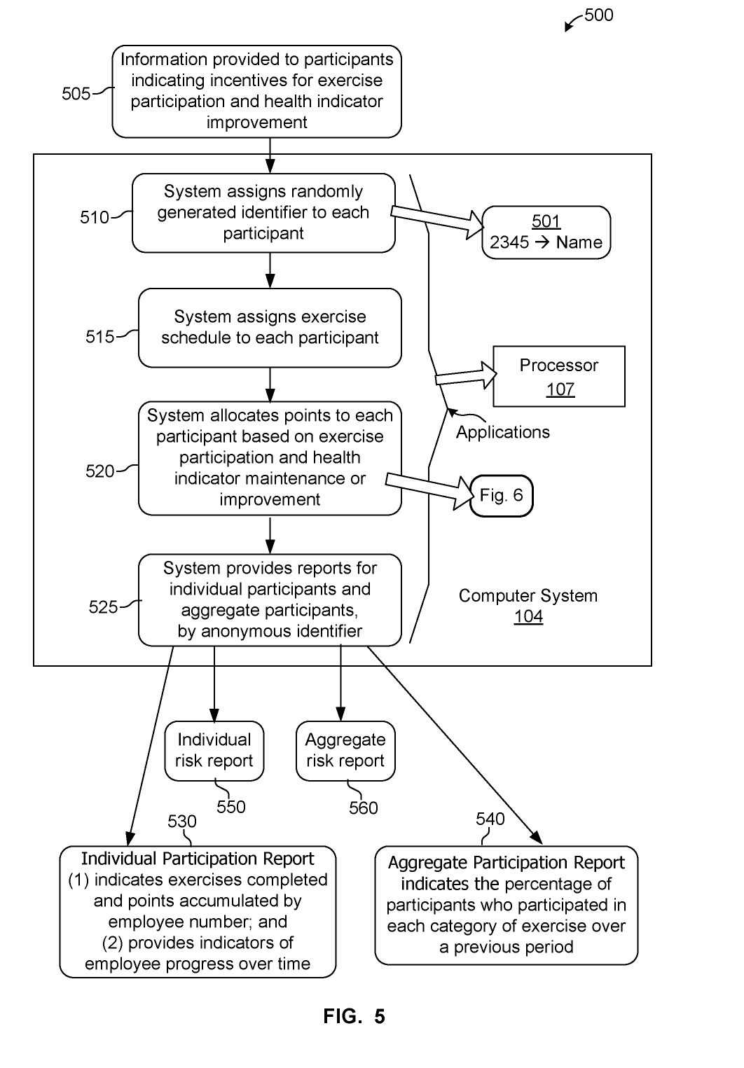

FIG. 5 is a flowchart showing an exemplary set of high level steps performed to incentivize (provide incentive for) and reward individual improvement in exercise participation and health metrics, without an administrating employer's knowledge of individual health data, in an exemplary embodiment 500 of the present system. The method shown in embodiment 500 is performed by algorithms 145, stored in database 105 and executed on processor 107 in computer system 104. As shown in FIG. 5, at step 505, information is provided, by an administrating employer, to participants indicating incentives for exercise participation and health metrics improvement. In an exemplary embodiment, an employer may provide incentives in the form of prizes for qualifying participants. These prizes may include gift items such as an electronic device or gift card, or other rewards, such as a higher percentage of a participant's health insurance being covered by the employer. From an employee standpoint, when a participating employee maintains or improves on health metrics, or simply participates in assigned exercises, the present system awards points to the participant.

Accordingly, a prize or other incentive may be provided by the employer to each participant who accumulates a predetermined number of points. In the present method, mere participation in the program is not the goal, rather, the system tracks personal health data and assigns points based on a participant's ability to improve on sub-standard metrics or maintain already-healthy metrics. If a participating employee doesn't improve or maintain his/her results, the employee doesn't earn points, and thus will not be eligible for the incentives the employer has chosen for the program.

Participants have the ability to challenge co-workers or other departments (or groups) to earn points. The present system may be programmed to assign a specific number of points to each winner of a challenge. The duration of each particular challenge may be selected from a pre-defined set of timeframes.

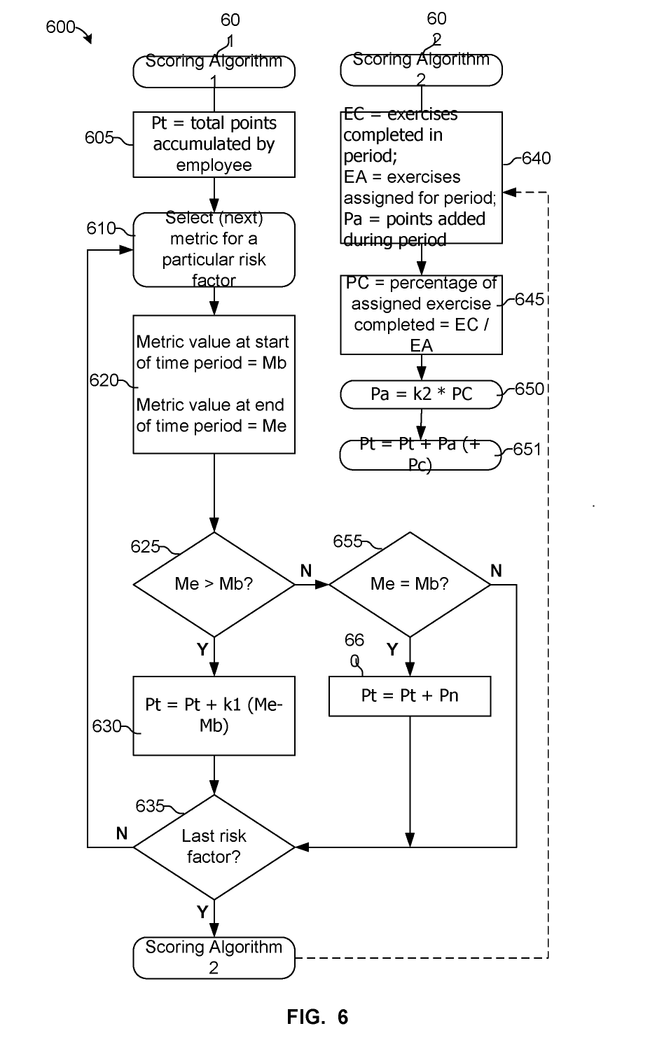

At step 510, the system assigns, to each employee/participant name, a randomly-generated identifier 501, such as a number or character sequence, so that the employer is not able to match personal HRA (health risk assessment) data in the present system with individual employees when system data is viewed by the employer. In one embodiment, the employer is able to see the percentage of its participating employees that have certain characteristics, such as high blood pressure, for example, but the employer cannot determine the identity of the individuals that comprise that group of participants, from any report generated, or from information, such as employee identifier 501, made accessible to the employer by the present system. This anonymity is accomplished through use of the randomly assigned employee identifiers 501 and a scoring algorithm, explained in detail below with respect to FIG. 6.

At step 515, system 104 assigns an exercise schedule to each participant, based on factors such as assessed health risk, ergonomic analysis of the participant's jobsite, and injury reports, as explained above.

At step 520, the system allocates points to each participant based on exercise participation and either the improvement of sub-standard health metrics or the maintenance of desirable health metrics. Participants earn points, in accordance with the scoring algorithm described below, by checking off that they have completed assigned exercises.

At step 525, the system may provide reports for both aggregate participants and individual participants, wherein each of the participants is referenced only by a randomly-generated identifier 501 (i.e., there is no information in the report that would enable an employer to determine the identify of any particular participant), so that an employer is not able to match personal HRA data with specific individuals. These reports may include an individual participation report 530, an aggregate participation report 540, an individual risk report 550 of individuals who fall into the ‘at risk’ category for each HRA metric of interest, and an aggregate risk report 560, which shows the percentage of the aggregate workforce that falls into the ‘at risk’ category for each HRA metric of interest.

FIG. 6 is a flowchart showing an exemplary scoring algorithm 600 in an exemplary embodiment of the present system. In one embodiment, the present system uses a two-part scoring algorithm 601/602 to determine, for each HRA, health metrics such as blood pressure, cholesterol levels, etc., for each employee participant. Points are assigned to participants based on participants' health risk situation and exercise participation and performance. Points may also be allocated to each participant whose exercise performance improves by a predetermined amount in a predetermined period of time. In the spirit of the present method, ‘points’ may be considered as anything of potential value offered in return for a predefined measure of HRA and/or other physical progress by a particular employee participant over some period of time. As shown in FIG. 6, in an exemplary embodiment, two algorithms are employed to determine the total points (Pt, step 605) accumulated by a participant. A first algorithm 601 determines the points accumulated by the participant based on health risk factor status, and a second algorithm 602 determines the participant's total points based on the percentage of assigned exercises completed, and points won in challenges.

At step 610, a specific health metric is selected, per scoring algorithm 601. Health metrics may include weight, blood sugar, blood pressure, cholesterol, BMI, alcohol use, tobacco use, and so forth. Given a health metric value Mb at the beginning of a selected time period, and a value Me at the end of the time period (step 620), if (at step 625) Me is greater than Mb (i.e., if improvement was shown by the participant over that period), then the participant's total points (Pt) is set equal to his/her previous point total plus the Me−Mb differential times some predetermined constant, k1, at step 630. Values assigned to health metric maintenance and improvement are determined in accordance with a predetermined scheme or formula, which can be adjusted as necessary during the term of a particular incentive program.

In one embodiment, a participant's health metric current situation and history is represented by a color scheme. Green, yellow, and red ranges indicate good, cautionary, and critical situations, respectively, and these colors are based on medically acceptable ranges. If a ‘red’ metric changes to ‘yellow, or a ‘yellow’ metric changes to ‘green’, the participant is rewarded with a predetermined number of points. In another example, if someone begins with a ‘green’ metric which remains green, this is also rewarded with a predetermined (fewer) number of points, even though no improvement was shown. The points calculation is based on a participant's ability to improve their value or to maintain a green (good) value. For example, points may be awarded based on a scheme such as the following:
Red or yellow (changing) to green=2 points;
Red to yellow=1 point;
Yellow to yellow=0 points;
Yellow to red=−1 point;
Green to yellow=−1 point;
Green to red=−2 points.

The values assigned to this color metric scheme can be changed over time, to ‘tune’ the present incentive program. Neither employees nor employers will not know exactly how the algorithm assigns points based on changes in health metrics. Neither will not know, for example, if a 10 percent decrease in BMI is worth 1 point or 10 points.

If (at step 655) the Me−Mb differential is zero (i.e., if the participant's score did not change), then the participant is awarded a predetermined number of points, Pn, at step 660. If the Me−Mb differential is less than zero (i.e., if the participant's score declined), no additional points are awarded. If (at step 635) there is another health risk factor to evaluate, processing continues (at step 610) until points for all risk factors have been tabulated to compute an intermediate total point score, Pt, for the participant.

Scoring Algorithm 2 is executed next, to determine the participant's total points (Pt) based on points won in any challenges (Pc), and a weighted percentage of exercises completed versus exercises assigned. For Algorithm 2, in an exemplary embodiment, there are a possible 18 exercise points per week (maximum). The percentage of points received (e.g., 9 out of 18 =50%) is first calculated, then 1 point per every 10% exercise completion is then awarded. In this example, 9 ‘exercise’ points means an employee participant performed 50% of the exercises, which is worth 5 points.

As indicated at step 640, EC represents the number of completed exercises, EA represents the number of exercises assigned, and Pa represents the number of points to be added to a participant's total point score, Pt. At step 645, the percentage of exercises completed versus exercises assigned is computed, and the result is multiplied by a predetermined constant, k2, to yield a value for Pt for the selected time period, at step 650. At step 651, any optional points earned in challenges (Pn) are added to the present value for Pt to yield a final total for points earned by the participant during the selected time period.

Using one of the reports described further below, an employer can see that employee number 123, for example, accumulated, for example, 28 points for improving his health metrics, and is thus deemed the winner of a particular prize. Because an employer is not able to match personal HRA data with individual employee participants, however, the employer does not know what any specific employee's specific improvements (or digressions) were; rather only that the employee maintained high health metrics across the board, or improved on one or more previously low metrics. In this way, the scoring algorithms allow the employer to incentivize and reward individual improvement without ever knowing individual health data.

As shown in FIG. 5, an individual participation report 530 includes a short term and long term view of an employee's participation. This report allows an employer to determine the performance of their employees in a number of different ways—by exercise, strengthening vs. cardio, job classification, weekly points accumulated; all of which are reported by randomly assigned employee numbers rather than names.

The data in the individual participation report indicates the percentages of each of the exercises assigned to the employee that were completed. For example, if an employee were assigned three cardio exercises to complete for the week and only completed two of them, the report will show 66 percent completion of this exercise assignment. There may also be a weekly tabulation that indicates how many points each participant has accumulated over a selected time period.

An aggregate participation report 540 shows what percentage of employees participated in each category of exercise over a previous period such as this week, last week, last month, etc.

An individual risk ('stoplight') report 550 shows each employee participant's individual risk set to allow the employer to determine whether an employee's performance metrics are low risk. Values are displayed in green, indicating low risk, yellow (moderate risk) and red (risk). The report shows the areas where employees are at highest risk in terms of cholesterol, HDL, LDL, glucose, BMI, blood pressure and tobacco usage, thus allowing an employer to see where employee participants may need assistance. This data does not show names of employees, but rather only numbers randomly assigned by the system.

An aggregate risk report 560 shows a company's aggregate employee risk data at two points in time. Both a pie chart and a column graph may be used to show the number of employees at high risk at a selected date.

These reports 530, 540, 550, and 560 (indicated as 5XX in FIG. 1) let an employer quickly see aggregate improvement (or the lack thereof) from one time period to another. In addition, these reports, and the individual participant data behind them, allow an employer to identify and incentivize outcomes as well as participation.

### Pharmacy Management Module

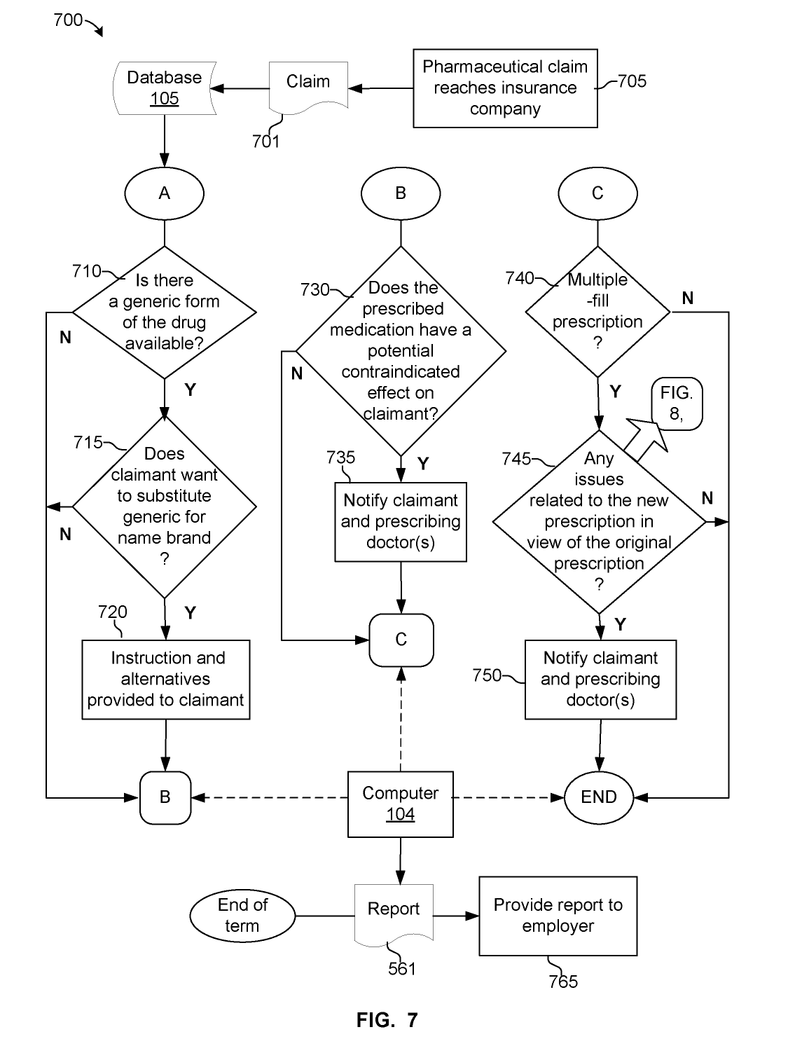

FIG. 7 is a flowchart showing an exemplary method 700 for managing pharmaceutical prescriptions. Method 700 is performed by algorithms in pharmacy management module (PMM) 150, stored in database 105 and executed on processor 107 in computer system 104. As shown in FIG. 7, at step 705, once a pharmaceutical claim 701 (filed for a prescription drug which has been purchased by a claimant) reaches the claimant's insurance company, the present system evaluates the presently-prescribed drug in three aspects, as indicated by the blocks labeled “A”, “B”, and “C”. The claim may be either workers' compensation insurance or standard group health insurance. In an exemplary embodiment, a comparison is made, in each of the aspects described below, between (a) the presently-prescribed medication(s) and (b) information, stored in database 105, concerning previously-prescribed medications.

In aspect ‘A’, at step 710, if there is a generic form of the presently prescribed drug available that has the same effect as the name brand (non-generic) drug, then, at step 715, if the claimant chooses to substitute the generic form of the drug for the retail name brand/non-generic form, the claimant is provided with instruction, such as guidance that such a decision is deemed appropriate or not, and alternatives. Alternatives may be selected from a source such Merck PDR, or from professional advice (as all consultants are preferably registered pharmacists) at step 720. This generic drug substitution will typically save money for the claimant (since the co-pay for generic drugs is typically less than the cost of name brand/non-generic drugs) and will also save money for the employer, since the total cost for the generic drug is less than that of the name brand/non-generic version. Evaluation of the presently-prescribed drug then continues at block B.

In aspect ‘B’, at step 730, a determination is made as to whether the prescribed medication will have any potential contraindicated effect on the claimant. This includes checking to see whether there are any potential contraindicated effects if the new prescription is taken along with any other medication presently prescribed by all doctors whom the claimant is seeing or whom the claimant has previously seen. For example, if the claimant is filling prescriptions from two or more doctors, does the medication prescribed by the claimant's personal physician negatively relate to the prescribed medication the employer's workers' compensation physician (to whom the same claimant was sent)? This approach is applicable, and may be effectively utilized, if the claimant uses different personal doctors (one doctor for one medical issue, and another doctor for a different issue) and the claimant fails to inform both doctors of all medications used. The present method also provides an additional safeguard against potential contraindicated effects of multiple medications prescribed by the same doctor. Therefore, if actual or potential problems with the prescribed medications are determined in the step 730 analysis, then the claimant and the prescribing doctor(s) are notified at step 735. Optional recommendations may be made by a pharmacist pursuant to step 715, above. Evaluation of the presently-prescribed drug then continues at block C.

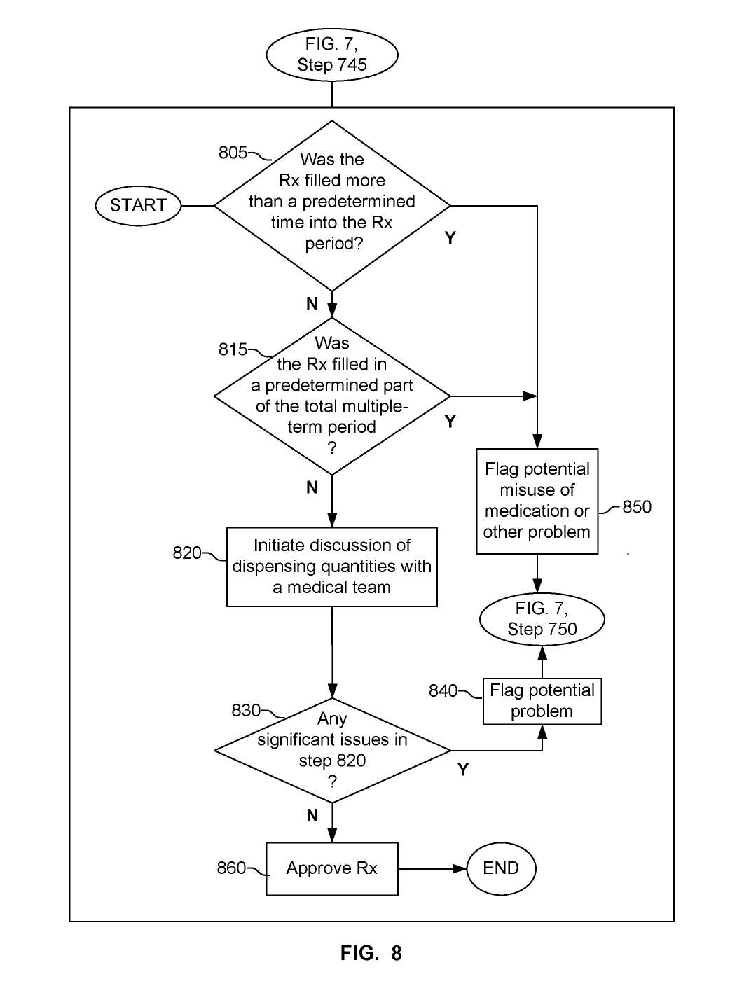

In aspect ‘C’, at step 740, if the claim is for a multiple-fill prescription, then, at step 745, the present method determines how the attempt to fill the prescription relates to the original prescription. For example, is the attempt to fill the present prescription 15 days into a 30 day prescription period? If so, this situation, which is common with pain medications, is flagged as a potential misuse of medication, to allow a pharmacist to contact the patient. Alternatively, for example, it is possible that the claimant received a prescription for three 30-day terms that hasn't been filled in two months. In this case, the claimant is not taking the medication as prescribed; this is also a common situation. Step 745 is described in detail below with respect to FIG. 8.

If actual or potential problems are determined in the step 745 analysis, then claimant and the prescribing doctor(s) and possibly dispensing pharmacist are notified and coordinated with pharmacy benefit management (‘PBM’, a common industry reference to pharmacy-related insurance processing) at step 750. The present method provides for effective management of the medications people are taking, while working to progress appropriate people off of indicated medications.

It is generally important to determine ‘clinically’ why a patient is refilling a prescription early—this is another area where the present system provides assistance. Situations that have previously resulted in inadequate pain control are remedied by the present solution, which helps the physician and patient choose a potentially more effective medication. If refill attempts are being made as a result of potentially fraudulent behavior, then this situation is handled accordingly in conjunction with PBM.

At the end of a pre-specified term (e.g., a year), system 104 provides a report 561 (with information in aggregate form) to the claimant's employer, at step 765. This report includes the number of interactions processed related to suggested transfers from retail to generic, and the number of interactions processed related to contraindicated medicines prescribed. The potential cost savings, as determined by estimated cost of not intervening and ensuing contraindication, may also be indicated in the report.

FIG. 8 is a flowchart showing exemplary details of step 745, FIG. 7. In step 745, PMM algorithms 150 are applied to analyze claim information (which is also stored in database 105) to determine possible timing issues related to the use of the prescribed medications and the filling of prescriptions for a particular claimant. As shown in FIG. 8, at step 805, it is determined whether the date on which the present prescription was filled is more than a predetermined period of time (e.g., 15 days) into the prescription period. If so, this prescription is flagged (in database 105) as a potential misuse of medication, and the claimant and the prescribing doctor(s) are notified, at step 850.

At step 815, a check is made to determine whether the present multiple-term prescription has been filled within a predetermined segment of the total multiple-term period. If not, then this situation is flagged (in system database 105), at step 850, as a potential misuse of medication, and the claimant and the prescribing doctor(s) are notified.

At step 820, general coordination and discussion among a medical team is initiated by messages sent from the present pharmacy management program to the physicians and the pharmacist, thus providing a mechanism to initiate a discussion of a particular patient's dispensing quantities, and possibly also initiate a consultation on behavioral issues, with the medical team. The medical team typically includes each of the prescribing physicians (where there are prescriptions from multiple physicians) and optionally a psychiatrist or psychologist and/or a pharmacist. At step 830, if the medical team determines that any significant issues with the prescription exist in step 820, e.g., if actual or potential timing issues related to the use or filling of prescriptions for the presently prescribed medication(s) are determined to exist, the prescription is flagged (in database 105) at step 850, as a potential misuse of medication, via manual input from a medical team member using an I/O device 180 such as a keyboard, at step 840. Processing continues as shown at step 750 in FIG. 7.

Any issues that are flagged at step 840 or step 850 are stored in system database 105 along with the corresponding patient's prescription information and history 123.

If checks 805, 815, and 830 do not indicate any actual or potential timing issues related to the use or filling of prescriptions for the presently prescribed medication(s), and no significant issues are determined to exist in step 820, then the claim is approved at step 860.

In summary, the present pharmacy management system insures that a patient is taking the appropriate medications, in an appropriate manner, and using generics when available.

Certain changes may be made in the above methods and systems without departing from the scope of that which is described herein. It is to be noted that all matter contained in the above description or shown in the accompanying drawings is to be interpreted as illustrative and not in a limiting sense. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. In a health plan including a plurality of participants, a computer-implemented method, administered by an employer, for incentivizing the participants' improvement in exercise participation and health metrics, without an employer's knowledge of the participants' individual health data comprising:
assigning a randomly-generated identifier to each of the participants;
assigning an exercise schedule to each of the participants;
allocating points to each participant based on exercise participation;
providing incentives for the participants, in the form of prizes awarded to each of the participants based on the number of points respectively allocated; and
generating reports indicating the degree of participation by aggregate participants and by individual participants.

2. The method of claim 1, wherein the points are allocated based on improvement, by a particular said participant, of sub-standard health metrics.

3. The method of claim 1, wherein the points are allocated based on the maintenance of desirable health metrics by a particular said participant.

4. The method of claim 1, including generating reports indicating one or more of an individual risk report for the participants in an ‘at risk’ category for one or more health-related metrics of interest, and an aggregate risk report which indicates the percentage of the aggregate workforce that falls within a predetermined at-risk category.

5. The method of claim 1, wherein the exercise schedule is based on factors including assessed health risk, ergonomic analysis of the participant's jobsite, and injury reports.

6. The method of claim 1, wherein the employer is able to see, from one of the reports, the percentage of participants that have one or more predetermined health-related issues, and wherein the employer cannot determine, from any of the reports, the identity of the participants.

7. A computer-implemented method for determining timing issues related to the use of prescribed medications and the filling of a prescription for a claimant comprising:
flagging the prescription as a potential misuse of medication, when the date on which the prescription was filled is more than a predetermined period of time into the prescription period; and
notifying the claimant and a prescribing doctor when a multiple-term prescription has been filled within a predetermined segment of the total multiple-term period.

8. The method of claim 7, including sending messages to a medical team comprising at least one prescribing physician and a pharmacist to initiate a discussion of a particular patient's dispensing quantities.
